(19) United States
(12) Patent Application Publication
(10) Pub. No.: US 2022/0285896 A1
(43) Pub. Date: Sep. 8, 2022

(54) MULTI RF-CONNECTOR SYSTEM

(71) Applicant: SPINNER GmbH, München (DE)

(72) Inventors: Robert Niebauer, Stephanskirchen (DE); Wolfgang Zißler, Feldkirchen Westerham (DE); Hans-Joachim Reijinga, Bad Feilnbach (DE)

(21) Appl. No.: 17/752,267

(22) Filed: May 24, 2022

Related U.S. Application Data
(63) Continuation of application No. PCT/EP2020/080805, filed on Nov. 3, 2020.

(30) Foreign Application Priority Data
Nov. 26, 2019 (EP) 19211464.3

(51) Int. Cl. H01R 24/40; H01R 13/639; H01R 13/52; H01R 24/86; H01R 13/629

(52) U.S. Cl. CPC H01R 24/40; H01R 13/639; H01R 13/5219; H01R 13/521; H01R 24/86; H01R 13/629

(57) ABSTRACT

An RF multi connector system includes a multi plug connector and a multi socket connector. The multi plug connector contains a plurality of first connectors circularly arranged around a center axis. The multi socket connector contains a plurality of second connectors circularly arranged around the center axis and matching to the corresponding first connectors of the multi plug connector. The multi plug connector additionally includes a lock rotor that is connected to a locking knob and that contains an outer thread having a plurality of longitudinal thread grooves. The outer thread matches to an inner thread of the multi socket connector.

### FIELD OF THE INVENTION

The invention relates to a multi coaxial connector system for radio frequency (RF) signals including a plurality of RF connectors.

### DESCRIPTION OF RELATED ART

US 2019/0312394 A1 discloses a ganged coaxial connector assembly. A pair of shells holds a plurality of mating connector pairs. The electrical contact system of each connector pair has a seal between each connector and its counter connector. Sealing is established each time, when the connectors of a connector pair are mated. This requires comparatively high plugging and unplugging forces which multiply with the number of connectors in a shell to very high total forces for plugging or unplugging a shell. To apply the high forces and to hold the connectors in predetermined axial positions, in embodiments with more than four connectors, the connectors are spring loaded. The space holding the springs and the space surrounding the connectors is not sealed, such that water may penetrate therein. When this water freezes, the spring does no more work, such that the sealing between the connectors may be affected. Further, freezing water expands and may damage the connector assembly. The locking mechanism comprising a latch and locking pin is outside of the connector and may freeze too. It is difficult to remove ice from the small parts such as the locking pins without damaging them. Finally, it may no more be possible to disconnect the coaxial connector assembly.

### SUMMARY

Embodiments of the invention provide a multi coaxial RF connector system having improved robustness, which is easy to connect and disconnect with lower forces and can be manufactured for reduced costs. Further, the connector system should be usable under freezing conditions.

In an embodiment, a RF multi connector system includes a RF multi plug connector and a RF multi socket connector matching to the RF multi connector.

The multi connector and the multi counter connector may hold a plurality of individual connectors, which may be coaxial RF (radio frequency) connectors. These coaxial connectors may be plug connectors, socket connectors, or hermaphroditic connectors. The multi plug connector comprises a housing for holding the individual RF connectors at predetermined positions. The multi socket connector comprises a further housing matching to the multi plug connector and which further comprises a plurality of positions for holding individual RF connectors. The connector holding positions of the multi socket connector match to the connector holding positions of the multi plug connector, such that the multi plug connector and the multi socket connector can be mated. The individual RF connectors at the multi plug connector and the multi socket connector are selected such that matching connector pairs exist. For example, an individual RF socket connector may be at a certain position at the multi plug connector, whereas an individual RF plug connector is at the corresponding position of the multi socket connector. There may be any order of plug and socket connectors and hermaphroditic connectors within the multi plug connector and the multi socket connector, as long as they match together. In addition, there may be other connectors, for example for grounding or for signal transmission.

The multi plug connector comprises a connector support protrusion which may have a shape matching to a connector support recess of a multi socket connector. The connector support protrusion may completely fit into the connector support recess, when the connectors are mated. The connector support protrusion may have cylindrical shape and may further have a circular, elliptical, rectangular or squared cross section. The multi plug connector and the multi socket connector may have a cylindrical shape with a locking mechanism at its center. All individual RF connectors may be arranged in a circle. Groups of RF connectors may be arranged in different circles. Basically, connectors may be arranged in one or in a plurality of circles around the center. In another embodiment, a plurality of the first connectors and a plurality of second connectors is arranged in a row or in a plurality of rows.

For higher frequencies, the dimension of the individual RF connectors decrease in size, and the structure of these connectors gets more and more delicate. Therefore, a straight insertion of the connectors when connecting the multi plug connector to the multi socket connector is necessary. Tilting or jamming of the connectors must be avoided under any circumstances. The centralized locking mechanisms together with the circular arrangement of the individual RF connectors results in a comparatively symmetric shape of the connector. The closing force is applied by the central locking mechanism, and therefore an even force distribution to the circularly arranged individual connectors is ensured. Furthermore, positioning and guiding grooves and notches may be provided in the multi plug connector and the multi socket connector. These grooves and notches further provide a straight guidance when connecting the multi plug connector with the multi socket connector.

To compensate for minor mechanical tolerances, the individual RF connectors may be fixed to their positions of the multi socket connector and the individual RF connectors at the multi plug connector may be mounted tiltable and/or movable in a radial direction thereto. This movability may only be within a comparatively small range which may be less than 2 mm, less than 1 mm, or less than 0.5 mm. An axial mobility is not required and may not be desired.

The central locking mechanism may comprise a threaded key and slot lock which is a combination of a thread and a key and slot connection. This will allow to engage the thread at a certain position and to generate a comparatively large distance of movement with a small angle of rotation. The locking mechanism may comprise a lock rotor at the multi plug connector and the lock stator at the multi socket connector. The rotor is rotatable and may be operated by a locking knob which may cover a larger section of the top surface of the multi plug connector or even all the top surface thereof. The lock stator may be fixed to the multi socket connector.

There may be a plurality of positioning notch/groove pairs which improve guidance when mating the connectors and may make multi plug connector/multi socket connector pairs unique, such that individual connectors cannot be combined with other connectors having notches and/or grooves at other position.

In an embodiment, at least one first coaxial RF connector may include a first sealing between a shaft of the at least one first coaxial RF connector and the plug connector housing. Further, at least one second coaxial RF connector may include a second sealing between a shaft of the at least one second coaxial RF connector and the socket connector housing. Also, at least one housing seal may be provided between the plug connector housing and the socket connector housing. There may be further housing seals such as a rotor seal to seal further openings into the housing, if for example a rotor is penetrating the housing.

Here, the interior of the connector housing including the connectors is sealed against dust, debris, humidity, and water from the outside. Therefore, no water may penetrate into the contact systems of the connectors. Further, no water may penetrate into the surrounding of the connectors, such that the connector may be operated (connected and disconnected) even at freezing temperatures, as no ice may block internal parts of the connector.

In an embodiment, there may be a combined seal for sealing the shafts of all of the at least one first coaxial RF connectors and the plug connector housing. The combined seal may also provide a seal of the rotor against the housing. Therefore, the combined seal is a combination of first sealing and second sealing.

Also, a solid locking knob on top of the connector can easily be cleaned from ice and be operated with thick globes. There exist no small parts outside the connector, which may be blocked by ice. The whole locking mechanism is embedded into the housing, such that it cannot freeze. In an embodiment, a key and slot locking mechanism may be provided to hold first coaxial RF connectors in the plug connector housing and/or second coaxial RF connectors in the socket connector housing. The mechanism may include a locking key at the connector and a locking slot at the housing. Such a locking mechanism simplifies insertion and/or exchange of the connectors into the housing.

In another embodiment, a locking mechanism using a slotted ring which may have a chamfered edge and is compressed for insertion of the connector, may be provided. When the connector is in place, the ring expands into a groove which is in the housing and locks the connector into the housing.

Further, a coaxial RF connector may be held by a nut on a thread on the shaft of the coaxial RF connector in the socket connector housing or the plug connector housing.

The embodiments of key and slot, slotted ring and nut do not need a spring for axially moving the connector.

The housings of the multi connector and the multi counter connector may comprise metal and/or a dielectric material such as a plastic or polymer material or the connectors may be coated with such a material at all contact surfaces which may enter into contact with the other connector. The connector housings may exclusively comprise of a dielectric material or multiple dielectric material. They may not comprise any metal or low impedance electrically conductive material. The only electrical connection between the multi connector and the multi counter connector may be by the coaxial RF connectors. This may improve passive intermodulation characteristics even if used in the close proximity of a radiating antenna.

The first and second coaxial RF connectors may be any combination of plug and socket connectors. In an embodiment, the RF multi connector system comprises only coaxial RF connectors, but there may be at least one or a low number of other connectors, for example power or signal connectors including optical connectors.

The abbreviation RF for radio frequency is used also for microwave.

In general, the features of the multi plug connector may be exchanged with the multi socket connector.

### BRIEF DESCRIPTION OF THE DRAWINGS

In the following, the invention will be described by way of example, without limitation of the general inventive concept, on examples of embodiment and with reference to the drawings.

FIG. 1 shows a perspective view of the RF multi connector system.

FIG. 2 shows a side view of an RF multi connector system.

FIG. 3 shows a detail of FIG. 2.

FIG. 4 shows further details in a sectional view.

FIG. 5 shows the multi plug connector in a partially disassembled state.

FIG. 6 shows a bottom view of the multi plug connector.

FIG. 7 shows a top view on the interface of the multi socket connector.

FIG. 8 shows lock rotor and lock stator in more detail.

FIG. 9 shows an exemplary curve of the locking distance versus rotation angle.

FIG. 10 shows a pair of mated coaxial RF connectors in detail.

FIG. 11 shows a key and slot locking mechanism.

FIG. 12 shows a locking mechanism using a slotted ring.

FIG. 13 shows a circular multi-row arrangement of coaxial RF connectors.

FIG. 14 shows a rectangular arrangement of coaxial RF connectors.

FIG. 15 shows a further embodiment with combined seal.

FIG. 16 shows a section of the previous figure.

FIG. 17 shows a rear view.

FIG. 18 shows a top view of the combined seal.

FIG. 19 shows a bottom view of the combined seal.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

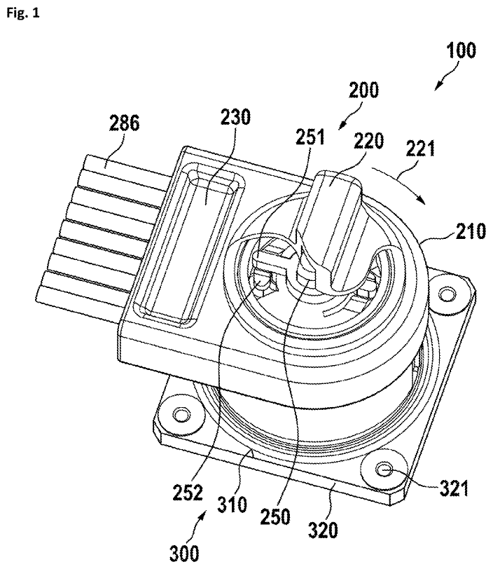

In FIG. 1, a perspective view of an embodiment of the RF multi connector system 100 is shown. It comprises a multi plug connector 200 and a multi socket connector 300. The multi plug connector 200 comprises a plug connector housing 210 with a locking knob 220 which may be rotated to lock or unlock the multi plug connector 200, as indicated by arrow 221. There may be a cord grip 230 to hold first cables for RF signals. The locking knob is partially cut to show part of the locking mechanism comprising a lock rotor 250. There may further be a lock, which may include a rotor arm 251 which interacts with a rotor notch 252 to hold the rotor in certain positions, which may be at least a locked position of the connector and an unlocked position. The lock may be part of the locking knob 220 or of the lock rotor 250. The socket connector comprises a socket connector housing 310 further comprises a mounting flange 320 having at least one flange screw-hole 321 for mounting the flange to a housing or an antenna or any other part.

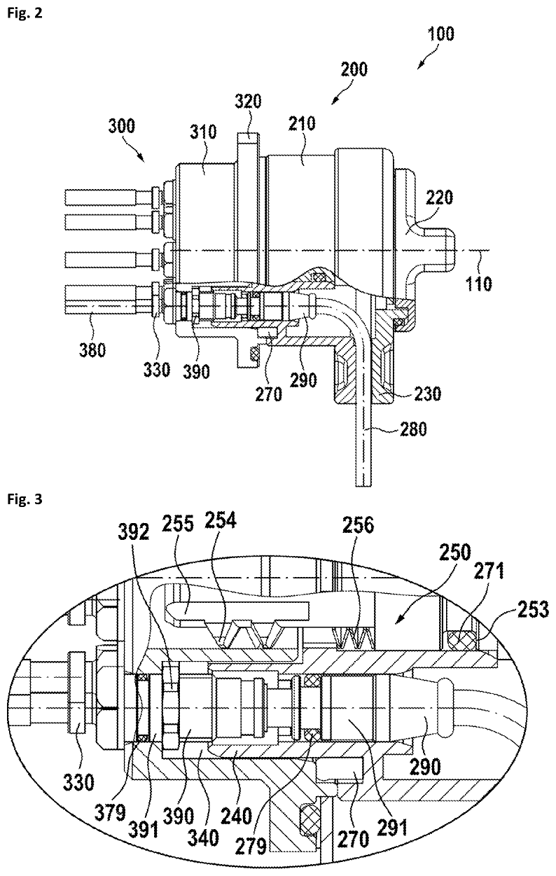

In FIG. 2, a side view of an embodiment of a RF multi connector system 100 is shown. The connector system has a center axis 110. Here again, the multi plug connector 200 is connected and locked with the multi socket connector 300. This Figure shows the individual RF connectors in more details. In the plug connector housing 210 of the multi plug connector 200, at least one first coaxial RF connector 290 is provided. This connector is attached to a first cable 280. The cord grip 230 prevents any mechanical force and at least pulling force by the first cable 280 to the first coaxial RF connectors 290. The first coaxial RF connectors 290 may be held within the housing either by a screw connection or a key and slot connection, which would provide easy exchangeability.

At the multi socket connector 300, at least one of the second connectors 390 is provided. These second connectors match to corresponding first connectors at the multi plug connector. The second connectors 390 are attached to second cables 380 for coupling RF signals thereto. A cord grip 330 at the multi socket connector avoids pulling force directly to the connector.

In an embodiment, at least one first coaxial RF connector 290 may include a first sealing 279 between a shaft 291 of the at least one first coaxial RF connector and the plug connector housing. Further, at least one second coaxial RF connector 390 may include a second sealing 379 between a shaft 391 of the at least one second coaxial RF connector and the socket connector housing. Also, at least one housing seal 271 may be provided between the plug connector housing and the socket connector housing. There may be further housing seals such as a rotor seal 271 to seal further openings into the housing, if for example a rotor is penetrating the housing.

There may be a housing seal, which may be a sealing ring 270 between the multi plug connector 200 and the multi socket connector 300 or at least between the plug connector housing 210 and the socket connector housing 310 to seal the connectors against dust, debris, humidity, and water from the outside. A lock rotor 250 may lock the multi plug connector 200 and the multi socket connector 300.

FIG. 3 shows a detail of FIG. 2. Here, the lock rotor 250 is shown in more detail. Furthermore, the connector support protrusion 240 is shown in a state mated with the connector support recess 340. This figure further shows a second coaxial RF connector 390 which is held by a nut 392 on a thread on the shaft 390 of a second coaxial RF connector 390 in the socket connector housing 310.

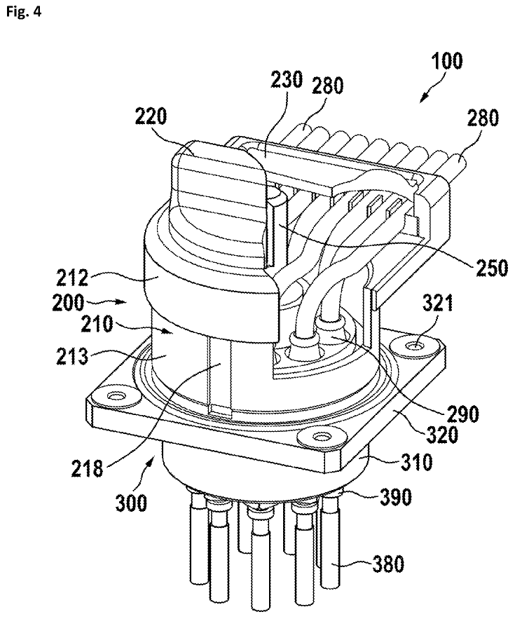

In FIG. 4, further details of an embodiment are shown in a sectional view. Here, an embodiment of internal cabling within the housing 210 of the multi plug connector 200 is shown. Multiple first connectors 290 are attached to multiple first cables 280 which are guided through the cord grip 230. The housing 210 comprises an upper shell 212 and a lower shell 213 which allows for easy assembly or disassembly of the housing. The first connectors 290 may be held by a snap-in mechanism within the lower shell 213 of the housing. An orientation groove 218 may be provided to indicate the correct direction of inserting the multi plug connector into the multi socket connector.

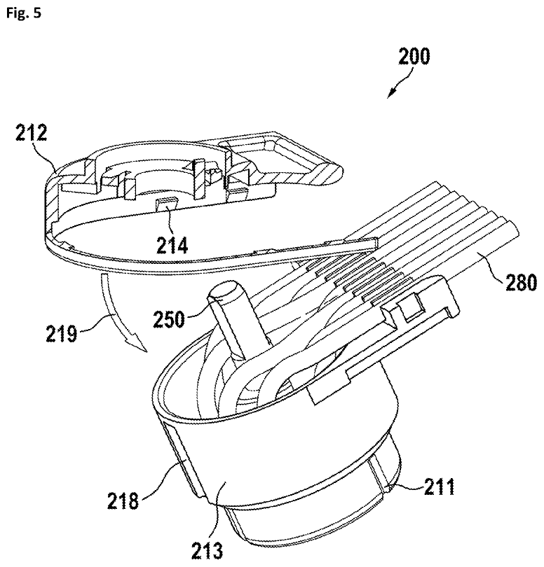

In FIG. 5, an embodiment of the multi plug connector is shown in a partially disassembled state. Here, the upper shell 212 is separated from the lower shell 213. It may be assembled to the lower shell 213 by a movement into direction 219. The upper shell and the lower shell together form cord grip 230, such that the individual first cables 280 may be easily inserted into the lower shell 213. The cord grip 230 is secured when the upper shell 212 is attached to the lower shell 213. The upper shell 212 may be locked by snapping hocks 214 to the lower shell. The multi plug connector 200 may provide at least one or a plurality of positioning grooves 211 which allow a precise positioning of the connectors and guide the connectors through the insertion process of the multi plug connector into the multi socket connector.

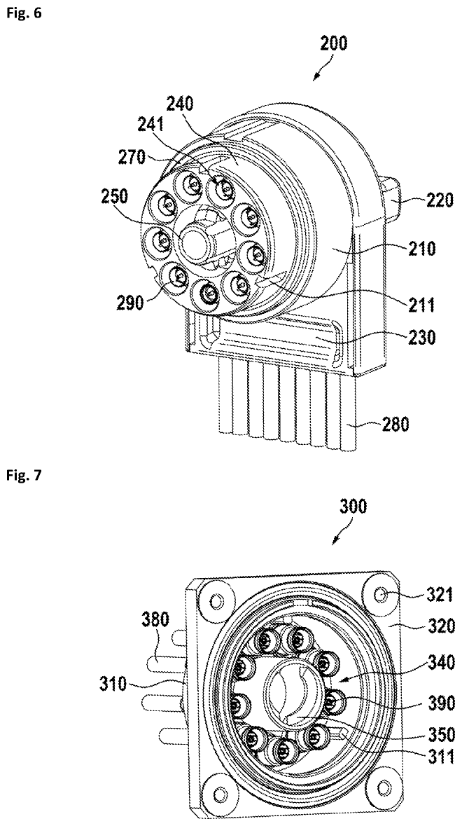

In FIG. 6, a bottom view of an embodiment of the multi plug connector 200 is shown. Here, the first coaxial RF connectors 290 can be seen from their connecting interface side. They are placed in connector recesses 241 of the connector support protrusion 240. The first coaxial RF connectors 290 may be placed in such a depth, that they do not protrude from the front surface of support protrusion 240. Therefore, they are protected from mechanical damage, when the connectors are not mated.

The connector support protrusion 240 has a shape matching to a connector support recess 340 of multi socket connector 300 which will be shown in one of the next figures. The connector support protrusion 240 may completely fit into the connector support recess 340, when the connectors are mated. The connector support protrusion 240 may have cylindrical shape and may further have a circular, elliptical, rectangular or squared cross section. There may be at least one positioning groove 211 which may interact with at least one positioning notch 311 of multi socket connector 300. There may be a plurality of such positioning notch/groove pairs which improve guidance when mating the connectors and may make multi plug connector/multi socket connector pairs unique, such that individual connectors cannot be combined with other connectors having notches and/or grooves at other position. In general, there may also be notches at the multi plug connector and grooves at the multi socket connector or vice versa. Furthermore, the lock rotor 250 is shown from its bottom side.

In FIG. 7, a top view on the interface of the multi socket connector 300 is shown. Here, second connectors 390 may be seen from their interface side. The second coaxial RF connectors 390 may be placed in such a depth, that they do not protrude from the front surface of connector support recess 340 and/or the mounting flange 320. Therefore, they are protected from mechanical damage, when the connectors are not mated.

This Figure also shows three positioning notches 311 which may interface with the positioning grooves 211 of the multi plug connector. Furthermore, the lock stator 350 is shown.

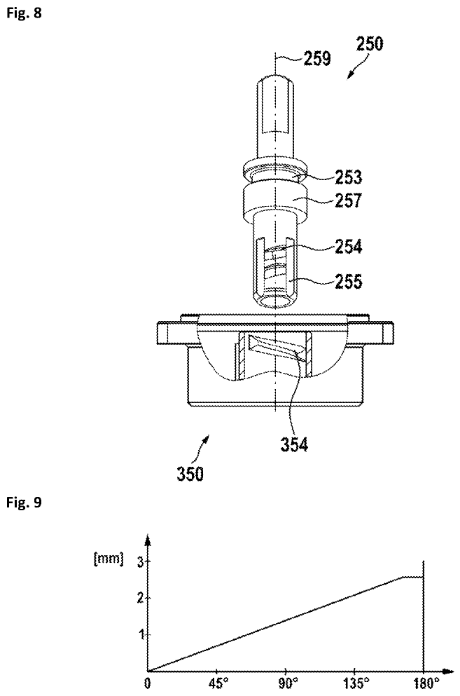

In FIG. 8, embodiments of the lock rotor 250 and the lock stator 350 are shown in more detail. The lock rotor 250 may have a seal grove 253 for a rotor seal 271 and a support section 257 configured to support a rotor spring 256 shown in more detail in the next figure. This rotor spring is shown there as a disc spring, but may also be an elastic sealing ring. This rotor spring may provide a tension between the connector housings, when in a locked state. The rotor center axis 259 may be the center axis of the multi plug connector 200 and the multi socket connector 300. The lock rotor 250 may be held by the multi plug connector 200 and it may have an outer thread 254 which interfaces with an inner thread 354 of the lock stator 350. In another embodiment, the multi socket connector 300 may include a lock rotor 250 which may comprise an outer thread 254 matching to an inner thread 354 of the multi plug connector 200. The outer thread 254 may be a combination of a thread and a key and slot lock. It may comprise only segments of a thread separated by grooves 255. At the top end opposing the thread, a locking knob 220 may be attached. There may also be a hex end for a hex nut, or any other end adapted for any tool, which may be a special tool to avoid unauthorized operation.

FIG. 9 shows an exemplary curve of the locking distance versus rotation angle of the locking movement of lock rotor 250. At angles between 0 and 160 degrees the movement between the connector housings is linear to a total distance of about 2.5 mm. With further rotation, there is no movement. This ensures in combination with a tensioning by the spring 256 a smooth and secure locking. Beyond the 160 degrees position, which may be close to a 180 degrees position, the lock 251, 252 may engage and block any unintentional rotation.

FIG. 10 shows an embodiment including a pair of mated coaxial RF connectors in a detailed sectional view. A first coaxial RF connector 290 is mated to a second coaxial RF connector 390. The first coaxial RF connector 290 comprises a first center conductor 293 which may have a male contact and a first outer conductor 294 which may be a solid tube. The second coaxial RF connector 390 comprises a second center conductor 393 which may have a female contact configured to contact the first center conductor 293 and a second outer conductor 394 which may be a slotted tube configured to contact the first outer conductor 294. The second coaxial RF connector 390 further comprises a second outer sheath 395 surrounding and protecting the slotted outer conductor. Male and female configurations of the inner and outer conductors may be exchanged.

The first coaxial RF connector 290 may comprise a first outer insulation 295 surrounding the first outer conductor 294. The first outer insulation 295 may center the first outer conductor 294 within the second outer sheath 395 and at the same time provides a galvanic insulation such that there is only one DC and low frequency current path of the outer conductors between the second outer conductor 394 and the first outer conductor 294.

This figure further indicates the distance 345 between the highest extension at front surface of multi socket connector 300 and the second outer sheath 395. So, the second coaxial RF connector 390 is set back within connector support recess 340 which provides a mechanical protection. Further, the distance 245 between the first coaxial RF connector 290 and the end of the connector support protrusion 240 is indicated. Also here, the first coaxial RF connector 290 is set back which provides a mechanical protection.

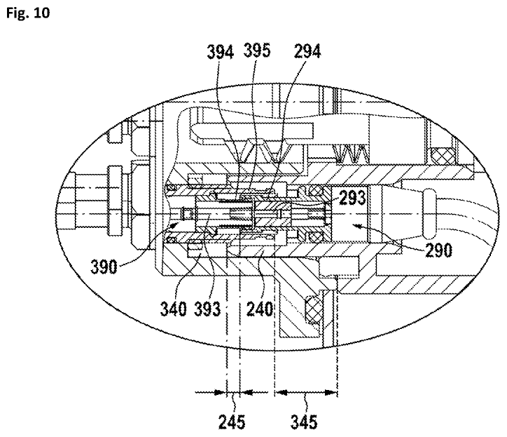

FIG. 11 shows an embodiment including a key and slot locking mechanism configured to hold first coaxial RF connectors 290 in the plug connector housing 210. The mechanism comprises a locking key 292 at the connector and a locking slot 272 at the connector support protrusion 240. For tensioning a connector sealing ring 279 may be provided. In addition or alternatively, the second coaxial RF connectors may have a key and slot locking mechanism. Such a locking mechanism simplifies insertion and/or exchange of the connectors into the housing. It further provides a precise positioning of the connectors within the housing.

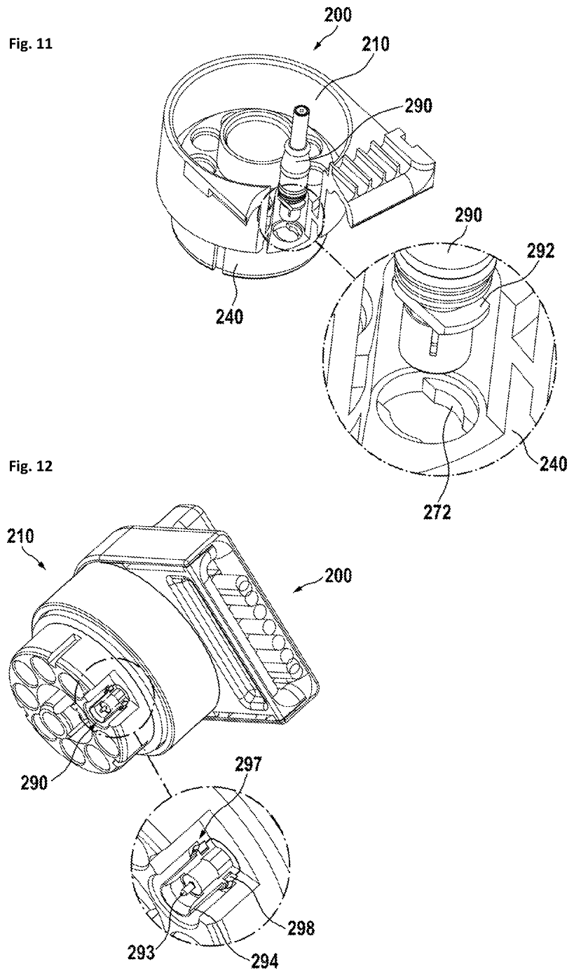

FIG. 12 shows an embodiment with a different locking mechanism using a slotted ring 298 which may have a chamfered edge and is compressed for insertion of the connector. When the connector 290 is in place, the ring expands into a groove 297 which is in the plug connector housing 210 and locks the connector 290 into the housing. This figure further shows a sectional view of a first coaxial RF connector 290 including a first center conductor 293 and a first outer conductor 294. In addition or alternatively, the second coaxial RF connectors may have a slotted ring mechanism. The slotted ring mechanism most simplifies assembly, as the connector may only be snapped into the housing.

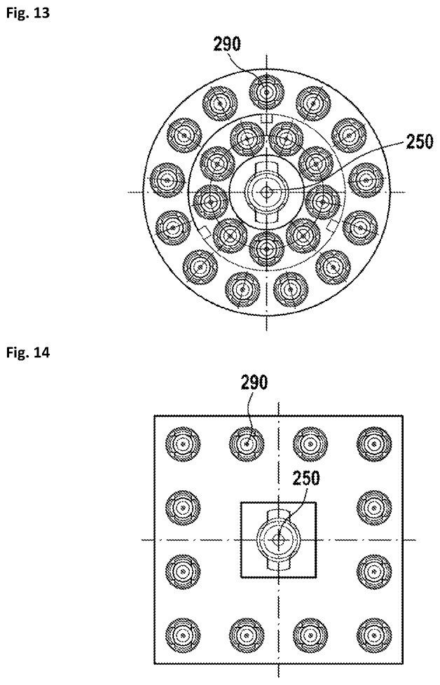

FIG. 13 shows a circular multi-row arrangement of coaxial RF connectors.

FIG. 14 shows a rectangular arrangement of coaxial RF connectors. These circular and rectangular embodiments basically show alternatives to the connector arrangements of FIGS. 5 and 6. Basically, any number of coaxial RF connectors may be provided.

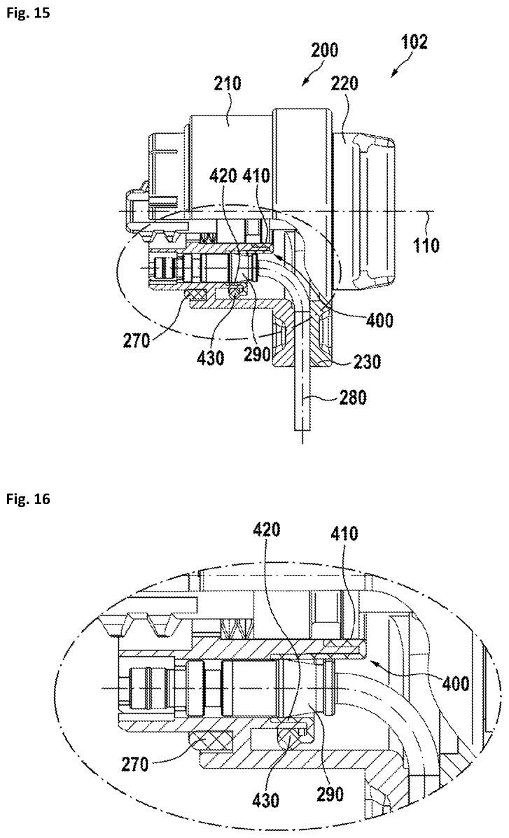

FIG. 15 shows a further embodiment of a RF multi connector system 102 with combined seal 400, which combines the function of first sealing 279 and second sealing 379. The combined seal may seal the shafts of all first coaxial RF connectors 290 against the plug connector housing. The combined seal may further seal the rotor against the housing.

FIG. 16 shows a section of the previous figure. Here, different sections of the combined seal 400 are shown in more detail. A center seal section 410 may provide a seal of the rotor. Multiple connector seal sections 420 seal the shafts of all first coaxial RF connectors 290. The outer seal section 430 contacts the housing and therefore provides a seal against the housing.

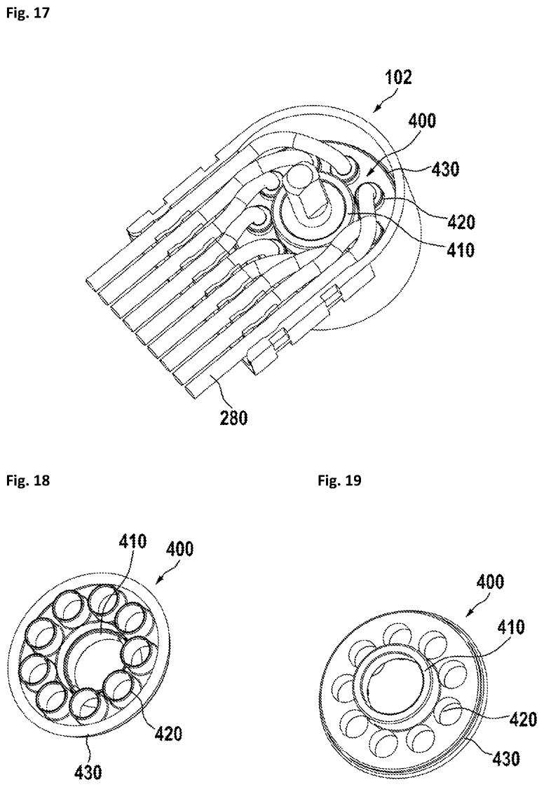

FIG. 17 shows a rear view a RF multi connector system 102 with a view on the combines seal 400.

FIG. 18 shows a top view of the combined seal with a center seal section 410, multiple connector seal sections 420, and an outer seal section 430. The center seal section 410 may include a protruding ring on a first side of the combined seal, located at the center of the combined seal. The connector seal sections 420 may be arranged around the center seal section. They may be arranged on a circle around a center axis of the combined seal. They may include multiple protrusions for accommodating the connectors. The protrusions may be oriented in or against an opposite direction to the center seal section. The outer seal section 430 may be a ring-shaped lip at the outer rim of the combined seal. It may also be on a protrusion. The combined seal may only include the connector seal sections 420 and the outer seal section 430 if the center seal section 410 is not required.

FIG. 19 shows a bottom view of the combined seal.

It will be appreciated to those skilled in the art having the benefit of this disclosure that this invention is believed to provide a RF multi connector system. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

100 RF multi connector system

102 RF multi connector system with combined seal

110 center axis

200 multi plug connector

210 plug connector housing

211 positioning groove

212 upper shell

213 lower shell

214 locks

218 orientation groove

219 assembly of connector housing shells

220 locking knob

221 rotation of locking knob

230 cord grip

240 connector support protrusion

241 connector recess

245 distance between first coaxial RF connector and connector support protrusion

250 lock rotor

251 rotor arm

252 rotor notch

253 seal groove

254 outer thread

255 thread grooves

256 rotor spring

257 support section

259 center axis

260 connector guidance bush

270 sealing ring

271 rotor seal

272 locking slot

279 first connector sealing ring

280 first cables

290 first coaxial RF connectors

291 shaft of first coaxial RF connector

292 locking key

293 first center conductor

294 first outer conductor

295 first outer insulation

297 groove in plug connector housing

298 slotted ring

300 multi socket connector

310 socket connector housing

311 positioning notch

320 mounting flange

321 flange screw hole

340 connector support recess

345 distance between second coaxial RF connector and multi socket connector

350 lock stator

354 inner thread

360 connector guidance socket

379 second connector sealing ring

380 second cables

390 second coaxial RF connectors

391 shaft of second coaxial RF connector

392 nut

393 second center conductor

394 second outer conductor

395 second outer sheath

400 combined seal

410 center seal section

420 connector seal sections

430 outer seal section

1. An RF multi connector system comprising a multi plug connector and a multi socket connector,
wherein the multi plug connector comprises a plug connector housing, the plug connector housing (210) further comprising a connector support protrusion having a plurality of connector recesses, the plurality of connector recesses each holding a first coaxial RF connector, each first coaxial RF connector comprising a center conductor and an outer conductor;
wherein the multi socket connector comprises a socket connector housing, the socket connector housing further comprising a connector support recess holding a plurality of second coaxial RF connectors,
wherein the multi plug connector matches to the multi socket connector such that the connector support protrusion fits into the connector support recess, and a plurality of first coaxial RF connectors matches to the plurality of second coaxial RF connectors, each second RF connector comprising an center conductor and an outer conductor;
wherein:
at least one first coaxial RF connector comprises a first sealing between a shaft of the at least one first coaxial RF connector and the plug connector housing,
at least one second coaxial RF connector comprises a second sealing between a shaft of the at least one second coaxial RF connector and the socket connector housing, and
at least one housing seal is provided between the plug connector housing and the socket connector housing.

2. An RF multi connector system according to claim 1, wherein the connector support protrusion has a circular outer contour around a center axis and the connector support recess has a circular inner contour around the center axis.

3. An RF multi connector system according to claim 1, wherein the plurality of the first coaxial connectors and the plurality of second connectors are arranged on a circle around a center axis.

4. An RF multi connector system according to claim 1, wherein the plurality of the first coaxial connectors and the plurality of second connectors are arranged in a row or in a plurality of rows.

5. An RF multi connector system according to claim 1, wherein the connector recesses (241) have a depth dimensioned such that the first coaxial connectors do not extend beyond the connector recesses.

6. An RF multi connector system according to claim 1, wherein the connector support recess has a depth dimensioned such that the at least one second connector does not extend beyond the connector support recess.

7. An RF multi connector system according to claim 1, wherein the connector support protrusion comprises at least one positioning groove or positioning notch matching to at least one positioning notch or positioning groove at the connector support recess.

8. An RF multi connector system according to claim 1, wherein:
the multi plug connector comprises a lock rotor, the lock rotor comprising an outer thread that matches to an inner thread of the multi socket connector,
or
the multi socket connector comprises a corresponding lock rotor said corresponding lock rotor comprising an outer thread that matches to an inner thread of the multi plug connector.

9. An RF multi connector system according to claim 8, wherein the lock rotor (250) is configured to rotate around a center axis.

10. An RF multi connector system according to one of claim 8 or 9, wherein the lock rotor is connected to a locking knob.

11. An RF multi connector system according to claim 8, wherein the outer thread of the lock rotor has a plurality of longitudinal thread grooves.

12. An RF multi connector system wherein:
the at least one first coaxial RF connector comprises a locking key and the plug connector housing comprises a matching locking slot at the connector support protrusion for forming a key and slot locking mechanism,.
and/or
the at least one second coaxial RF connector comprises a corresponding locking key and the socket connector housing comprises a corresponding matching locking slot at a connector support protrusion for forming the key and slot locking mechanism.

13. An RF multi connector system according to claim 1,
wherein:
the at least one first coaxial RF connector is held by a slotted ring in a groove of the plug connector housing,
and/or
the at least one second coaxial RF connector is held by a corresponding slotted ring in a groove of the socket connector housing.

14. An RF multi connector system according to claim 1, wherein:
the at least one first coaxial RF connector is held by a nut on a thread on a shaft of the at least one first coaxial RF connector in the plug connector housing,
and/or
the at least one second coaxial RF connector is held by a nut on a corresponding thread on a shaft of the at least one second coaxial RF connector in the socket connector housing.

15. An RF multi connector system according to claim 1, further comprising
a combined seal that combines a first sealing and a second sealing by providing a center seal section configured to seal a rotor, a plurality of connector seal sections configured to seal shafts of the plurality of the first coaxial RF connectors, and an outer seal section configured to seal the plug connector housing.

16. An RF multi connector system according to claim 9, wherein a rotation of the lock rotor is angularly limited to less than at least one of 360°, 270°, 180° and 90°.

17. An RF multi connector system according to claim 10, wherein the locking knob comprises a lock configured to hold the rotor at least in a locked position.
